(19) United States
(12) Patent Application Publication
(10) Pub. No.: US 2008/0062012 A1
(43) Pub. Date: Mar. 13, 2008

(54) Passenger pick-up bus stop notification system

(76) Inventor: Greg Diep, Issaquah, WA (US)

Correspondence Address: DEAN A. CRAINE;STE 140, 400-112TH AVENUE NE, BELLEVUE, WA, 98004, US

(21) Appl. No.: 11/899,703

(22) Filed: Sep. 7, 2007

Related U.S. Application Data
(60) Provisional application No. 60/843,287, filed on Sep. 7, 2006.

(51) Int. Cl. G08G 1/123

(52) U.S. Cl. 340/994

(57) ABSTRACT

A passenger pick-up bus stop notification system designed to help bus drivers to determine if passengers at a bus stop used by different bus routes desired to be picked up. The system includes a display panel mounted on a vertical post installed adjacent to the roadway that services the bus stop. The display panel is designed to display a plurality of bus route numbers capable of viewed from a distance by an approaching bus driver. Directly or wirelessly coupled to the display is an input key pad that passengers used to input a bus route number on the display panel. The key pad may be mounted on the same vertical post used to mount the display or mounted at a separate location. The sign may include a solar panel and battery which provides electrical energy to the display panel and key pad. During use, waiting passengers input the bus route they desire to take which is presented on the display panel. When the bus driver sees the bus route number on the display, he or she knows a passenger is waiting at the bus stop. If the bus driver's bus route is not illuminated, the bus driver knows to by-pass the bus stop altogether

This is a utility patent application which claims benefit of U.S. Provisional Application No. 60/843,287 filed on Sep. 7, 2006.

### BACKGROUND OF THE INVENTION

1. Field of the Invention

This invention pertains to visual notification systems, and more particularly to notification systems used by passengers waiting at a bus stop to inform drivers of an approaching bus that passengers at the bus stop desire to be picked-up.

2. Description of the Related Art

Most bus transit systems construct bus stops along roadways where passengers wait for a bus. Many bus stops are shared by different bus routes. Typically, the bus transit system assigns a two or three digit route number to each bus route which is printed on a flier or sign posted at the bus stop. Often, the bus route number is also displayed on a LED panel located in the front of the bus to inform passengers waiting at the bus stop that the approaching bus is following the indicated bus route.

When a bus driver approaches a bus stop where passengers are waiting, he or she does not know how many passengers, if any, are waiting for a bus on their particular bus route. As a result, the bus drivers are forced to stop at every bus stop where passengers are waiting and open the doors to see if any passengers enter the bus. If no passengers enter the bus, the bus driver quickly closes the door and continues along the bus route. Needless to say, for buses to unnecessarily stop at bus stops where no passengers are waiting is not efficient.

What is needed is a notification system capable of being used at a bus stop that waiting passengers used to inform the driver of an approaching bus that they are waiting for a bus on a particular bus route. Such a system should be easy to use and inexpensive to implement.

### SUMMARY OF THE INVENTION

It is an object of the present invention to provide a notification system for passengers waiting for a bus driven on a particular bus route at a bus stop shared by different bus routes.

It is another object of the present invention to provide such a notification system that enables drivers to visually determine from a distance whether passengers are waiting for a bus on his or her bus route.

It is another object of the present invention to provide such a system that is relatively easy to use and inexpensive to implement.

These and other objects are met by the invention disclosed herein that includes a bus route notification sign with an elevated display panel mounted on an elevated structure, such as the end of a vertical pole. The elevated structure is installed at a location adjacent to the roadway where an approaching bus is driven so that an approaching bus driver can see whether the bus route number of the bus he or she is driving is illuminated on the sign's display panel. If the bus route number is illuminated, the bus driver knows that at least one passenger is waiting at the bus stop. If the bus driver's bus route is not illuminated, the bus driver knows to by-pass the bus stop altogether.

In the preferred embodiment, the display panel is designed to display a plurality of bus route numbers capable of being viewed from a distance by the driver of an approaching bus. Coupled to the display is an input key pad that passengers used to input a bus route number which is then shown on the display. In the preferred embodiment, the key pad is mounted at a convenient location the vertical pole used to support the display panel. The sign may include a solar panel and storage battery which provides electrical energy to the display and key pad.

### DESCRIPTION OF THE DRAWINGS

FIG. 1 is a top view illustration of a bus approaching a bus stop where a group of passengers waiting for buses used on different routes are waiting.

FIG. 2 is a perspective view of the notification sign.

FIG. 3 is an electrical schematic illustration of the notification system.

### DESCRIPTION OF THE PREFERRED EMBODIMENT(S)

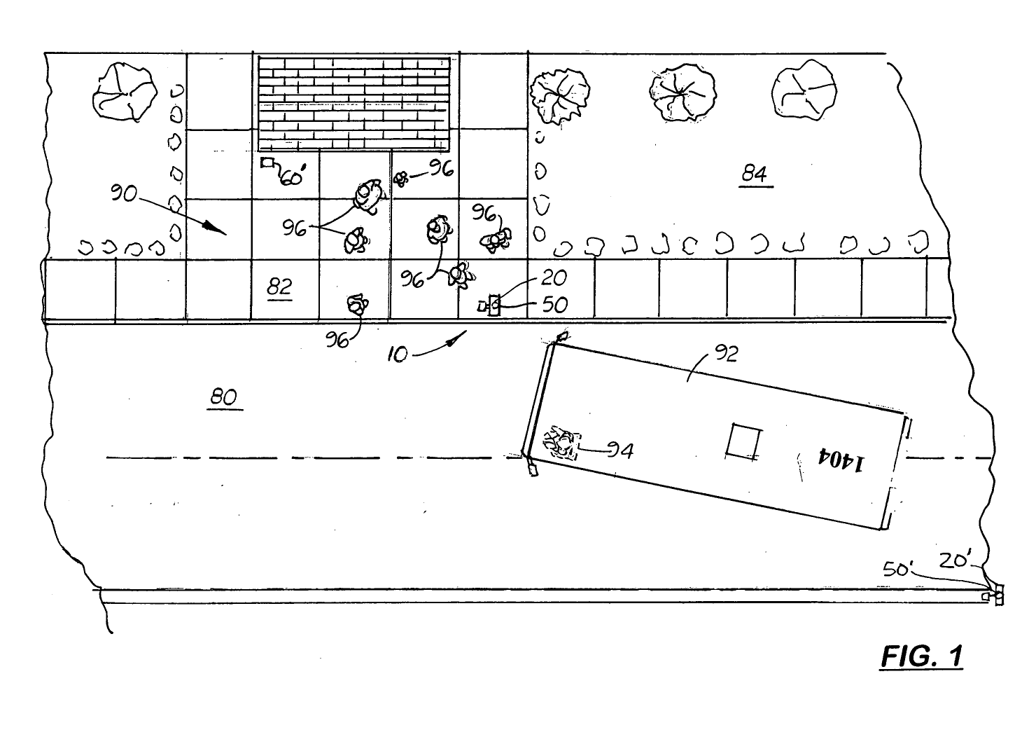

Referring to the accompanying Figs, there is shown a notification sign 10 with an elevated display panel 20 mounted on the upper end of a vertical pole 50. The sign 10 is designed to be installed on a sidewalk 82 adjacent to the roadway 80 or parking area 84 at the bus stop 90 so that the driver 94 of an approaching bus 92 can see the bus route numbers displayed in the display panel 20 are illuminated. As shown in FIG. 1, in some instances the pole 50 or a second pole 50′ maybe located at an entry lane to the bus stop 90 so that the driver can view the display 20 or 20′ before leaving the main roadway. If a bus route number is illuminated on the display panel 20, the bus driver 94 knows that at least one passenger 96 is waiting at the bus top 90 to be picked-up. If the bus route number is not illuminated, the bus driver 94 knows no passengers are waiting and that he or she may by-pass the bus stop 90 altogether.

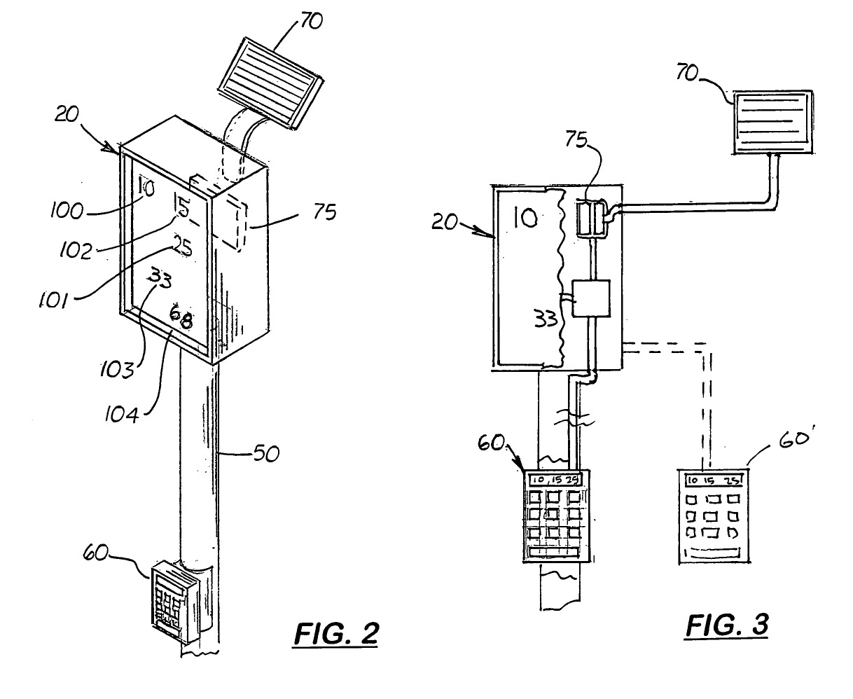

As shown in FIGS. 2 and 3, the display panel 20 is designed to display a plurality of bus route numbers 100-104 capable of being viewed from a distance by the bus driver 94. Coupled to the display panel 20 is an input key pad 60 that waiting passengers 96 used to input a bus route number on the display panel 20. In the preferred embodiment, the input key pad 60 is mounted on or near the mid-line axis on a vertical pole 50 and directly wired to the display 20. In other applications, the input key pad 60′ may be mounted at a separate location away from the display 20 or 20′, such as in the designated passenger waiting area. When the display 20, 20′ or key pad 60, 60′ are separated, they may be wired or wireless connected.

Mounted on the display panel 20 or to vertical pole 50, 50′ is an optional solar panel 70 and battery 75 which provides electrical energy to the display panel 20 and to the key pad 60.

Also disclosed herein, is a method of notifying a bus driver that a passenger is waiting for the bus, comprising the following steps:

a. installing a notification sign at bus stop that is used on different bus routes, said sign including a mounting structure for holding a display panel in an elevated position for viewing by a driver of an approaching bus, said display panel capable of displaying a plurality of bus route numbers visible to the driver, an input key pad located at said bus stop coupled to said display panel enabling a passenger to selectively enter a desired bus route number therein and displayed on said display panel;

b. entering the bus route number into said input key pad which is displayed on said display panel;

c. approaching said bus stop by a bus driven by a bus driver traveling on a bus route that picks up passengers at said bus stop;

d. said driver viewing said display panel to determine if the bus route number is presented; and,

e. stopping at the bus stop if the bus route number corresponding to the bus route of said bus is displayed or by-passing said bus stop the bus route number is not displayed.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A passenger pickup bus stop notification system, comprising:
a. a mounting structure;
b. a display panel attached to the upper end of said mounting structure, said display capable of displaying a plurality of bus route numbers each said bus route number being sufficient in size for a driver of an approaching bus to see; and,
c. a key pad coupled to said display, said key pad enabling a bus passenger to input a desired bus route number into said display panel for viewing by a bus driver approaching the bus stop.

2. The bus stop notification system, as recited in claim 1, further including a solar panel and battery coupled to said display panel.

3. The bus stop notification system, as recited in claim 1 wherein said display is mounted on an elevated structure.

4. The bus stop notification system, as recited in claim 1, wherein said elevated structure is a vertical pole.

5. The bus stop notification system, as recited in claim 4, wherein said key pad is attached to said vertical pole.

6. The bus stop notification system, as recited in claim 1, wherein said display panel is located at the bus stop entry location and said key pad is located in the passenger waiting area.

7. A method for notifying a bus driver that a passenger at a bus stop is waiting to be picked-up, comprising the following steps:
a. installing a notification system at a bus stop, said system includes an elevated mounting structure with a display panel attached at an elevated end, said display panel capable of displaying a plurality of bus route numbers visible to the driver of an approaching bus, said system also including a key pad coupled to said display panel enabling a passenger to selectively enter a desired bus route number therein which is then transmitted to said display panel;
b. selecting a passenger desiring to take a bus route on which said bus stop is used;
c. entering the bus route number into the key pad which is then displayed on said display panel;
d. selecting a bus driven by a bus driver approaching the bus stop and viewing said display panel to determine whether the bus route number of the bus is displayed; and,
e. stopping at the bus stop if the bus route number is displayed or continuing to travel past said bus stop if the bus route number is not displayed on said displayed panel.
